(19) United States
(12) Patent Application Publication
(10) Pub. No.: US 2025/0313352 A1
(43) Pub. Date: Oct. 9, 2025

(54) SYSTEMS AND METHODS FOR LATCHING AND FASTENING OBJECTS FOR IN-SPACE SERVICING, ASSEMBLY, AND MANUFACTURING

(71) Applicant: Enduralock, LLC, Lenexa, KS (US)

(72) Inventors: Harold Hess, Leawood, KS (US); Deeptesh Selvaraj, Pitt Meadows (CA); Zoltan Szekely, Cypress, TX (US); Jonathan Poulter, Denver, CO (US)

(21) Appl. No.: 19/170,203

(22) Filed: Apr. 4, 2025

Related U.S. Application Data
(60) Provisional application No. 63/631,431, filed on Apr. 8, 2024.

(51) Int. Cl. B64G 1/64

(52) U.S. Cl. CPC B64G 1/6462

(57) ABSTRACT

A docking system for use with in-space structures includes a first connector attached to a first in-space structure. The first connector includes a first housing defining a central axis and an engagement mechanism positioned within the first housing. The engagement mechanism is movable relative to the first housing. The docking system further includes a second connector attached to a second in-space structure. The second connector includes a second housing including a base and a connection member. The engagement mechanism is operable to engage the connection member. The connection member is fixed in position on the second in-space structure and does not move relative to the second in-space structure when the engagement mechanism engages the connection member.

### CROSS-REFERENCE TO RELATED APPLICATION

This application claims priority to U.S. Provisional Application Ser. No. 63/631,431, filed on Apr. 8, 2024, the contents of which are hereby incorporated by reference in their entirety.

### BACKGROUND

The field of the disclosure relates generally to latching and fastening mechanisms, and more specifically to docking systems including latching and fastening mechanisms for in-space servicing, assembly, and manufacturing.

In-space structures such as satellites and space stations orbit around planets or other gravitational bodies and provide many services for humans. For example, satellites have become crucial for use in systems that are vital in humans daily lives such as telecommunication and global positioning systems. However, the in-space structures can be difficult and expensive to assemble and maintain. For example, some satellites must be assembled or repaired while the satellite is in orbit. The systems to assemble or repair the in-space structures require precise handling and positioning of the in-space structures and parts. However, the components may be difficult to control remotely or in space. In addition, it can be expensive and difficult to include active coupling mechanisms to every in-space structure.

Therefore, there is a need for systems and methods for latching and fastening objects for in-space servicing assembly, and manufacturing.

### BRIEF DESCRIPTION

In one aspect, a docking system for use with in-space structures is provided. The docking system includes a first connector attached to a first in-space structure. The first connector includes a first housing defining a central axis and an engagement mechanism positioned within the first housing. The engagement mechanism is movable relative to the first housing. The docking system further includes a second connector attached to a second in-space structure. The second connector includes a second housing including a base and a connection member. The engagement mechanism is operable to engage the connection member. The connection member is fixed in position on the second in-space structure and does not move relative to the second in-space structure when the engagement mechanism engages the connection member.

In another aspect, a method of connecting in-space structures is provided. The method includes moving a first in-space structure relative to a second in-space structure. The first in-space structure includes a first connector including a first housing defining a central axis and an engagement mechanism positioned within the first housing. The engagement mechanism is movable relative to the first housing. The second in-space structure includes a second connector including a second housing. The second housing includes a base and a connection member. The method further includes engaging with the engagement mechanism the connection member within the engagement mechanism. The connection member is fixed in position on the second in-space structure and does not move relative to the second in-space structure when the engagement mechanism engages the connection member.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a securable assembly including a first structure and a second structure secured together by a docking system;

FIG. 2 is a cross-section view of a first structure, a second structure, and the docking system shown in FIG. 1, taken along the line 2-2 shown in FIG. 1;

FIG. 3 is an exploded perspective view of the first structure and a first connector of the docking system shown in FIG. 1;

FIG. 4 is an exploded perspective view of the second structure and a second connector of the docking system shown in FIG. 1;

FIG. 5 is a perspective section view of the docking system shown in FIG. 1, taken along the line 2-2 shown in FIG. 1;

FIG. 6 is an exploded side view of the first connector shown in FIG. 3;

FIG. 7 is an exploded side view of the second connector shown in FIG. 4;

FIG. 8 is a cross-section of a portion of the securable assembly shown in FIG. 1, taken along the line 2-2 shown in FIG. 1, with the docking system in an approach configuration;

FIG. 9 is a perspective view of the first structure of FIG. 1;

FIG. 10 is a perspective view of the first connector of the docking system;

FIG. 11 is an end view of the first connector;

FIG. 12 is a side view of the first connector;

FIG. 13 is a perspective view of a cam ring of the first connector’

FIG. 14 is a perspective view of the second structure;

FIG. 15 is a perspective view of the second connector;

FIG. 16 is an end view of the second connector;

FIG. 17 is a side view of the second connector;

FIG. 18 is a cross-section of the portion of the securable assembly shown in FIG. 8, with the docking system in a soft latch configuration;

FIG. 19 is a cross-section of the portion of the securable assembly shown in FIG. 8, with the docking system in a soft dock configuration;

FIG. 20 is a cross-section of the portion of the securable assembly shown in FIG. 8, with the docking system in a hard dock configuration;

FIG. 21 is a cross-section of the portion of the securable assembly shown in FIG. 8, with the docking system in a soft undock configuration;

FIG. 22 is a cross-section of a portion of the securable assembly shown in FIG. 1, showing fluid valve assemblies in an uncoupled configuration; and

FIG. 23 is a cross-section of the portion of the securable assembly shown in FIG. 23, showing the fluid valve assemblies in a coupled configuration.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

Relative descriptors used herein such as upward, downward, left, right, up, down, length, height, width, thickness, and the like are with reference to the figures, and not meant in a limiting sense. Additionally, the illustrated embodiments can be understood as providing example features of varying detail of certain embodiments, and therefore, features, components, modules, elements, and/or aspects of the illustrations can be otherwise combined, interconnected, sequenced, separated, interchanged, positioned, and/or rearranged without materially departing from the disclosed docking systems. Additionally, the shapes and sizes of components are also examples and can be altered without materially affecting or limiting the disclosed technology.

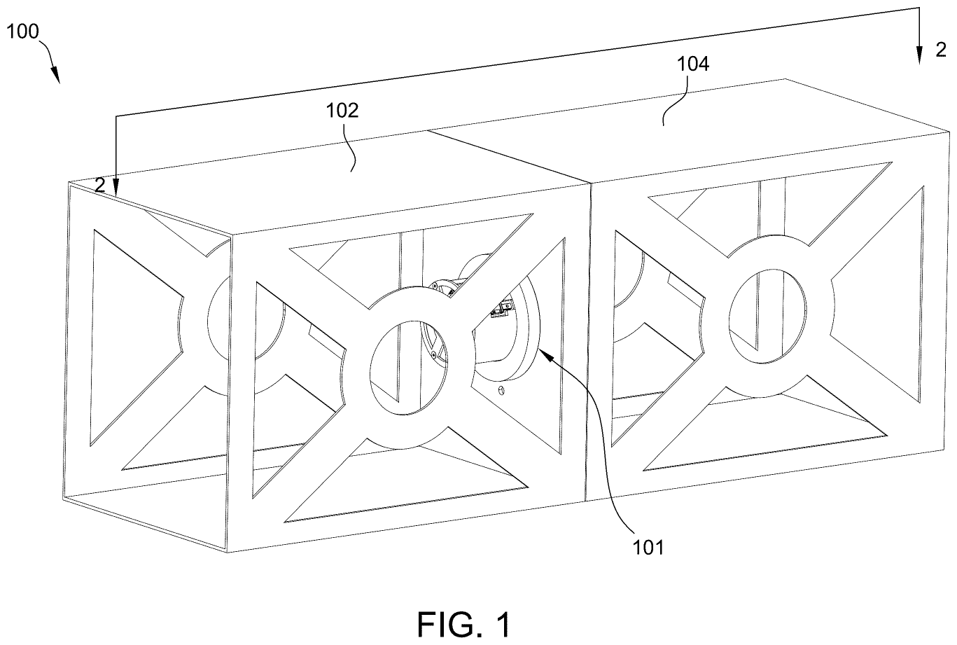

FIG. 1 is a perspective view of a securable assembly 100 including two structures 102, 104. For example, the structures 102, 104 are in-space structures, such as CubeSats, nanosatellites, and/or Evolved Expendable Launch Vehicle Secondary Payload Adapter (ESPA). For example, the in-space structures may have a size in a range of 1 CubeSat unit to 27 CubeSat units or larger. In other embodiments, the structures 102, 104 may be other structures without departing from aspects of the disclosure. For example, the structures 102, 104 may be incorporated into and/or coupled to larger structures. In the example, the structures 102, 104 each have two opposed ends and sides extending between the opposed ends. The structures 102, 104 are secured together in an end-to-end or stacked manner. Also, in the example, the structures 102, 104 may be cubes. However, the structures 102, 104 may be other sizes and shapes without departing from aspects of the disclosure. In addition, the first structure 102 may be a size and/or shape that is different than the size and/or shape of the second structure 104.

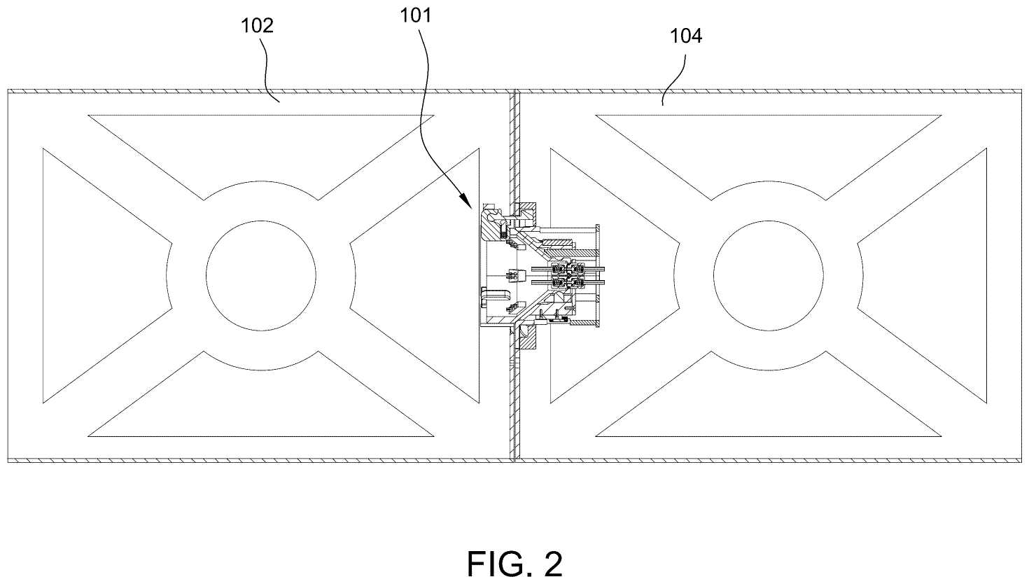

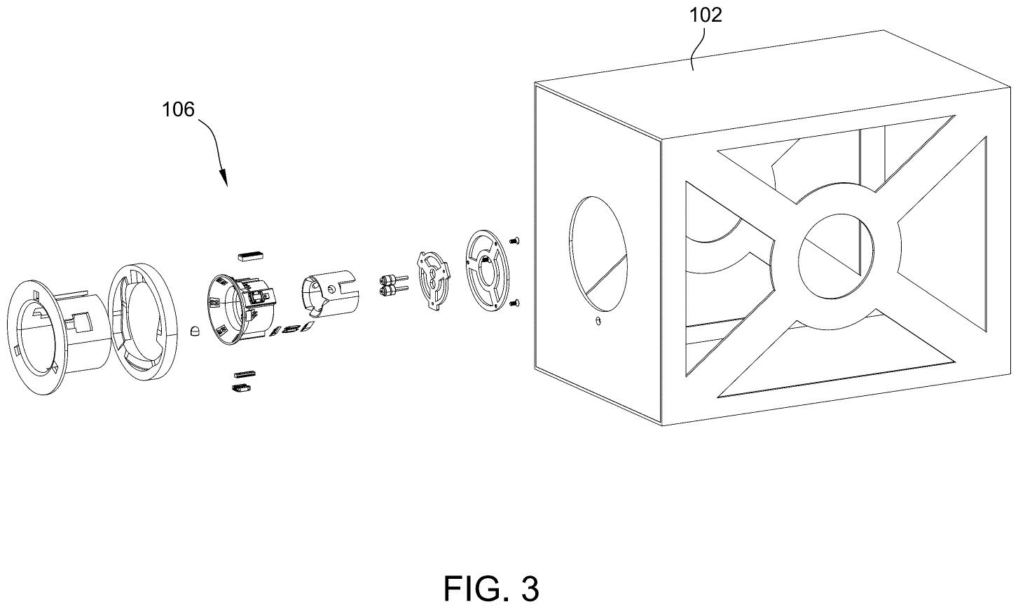

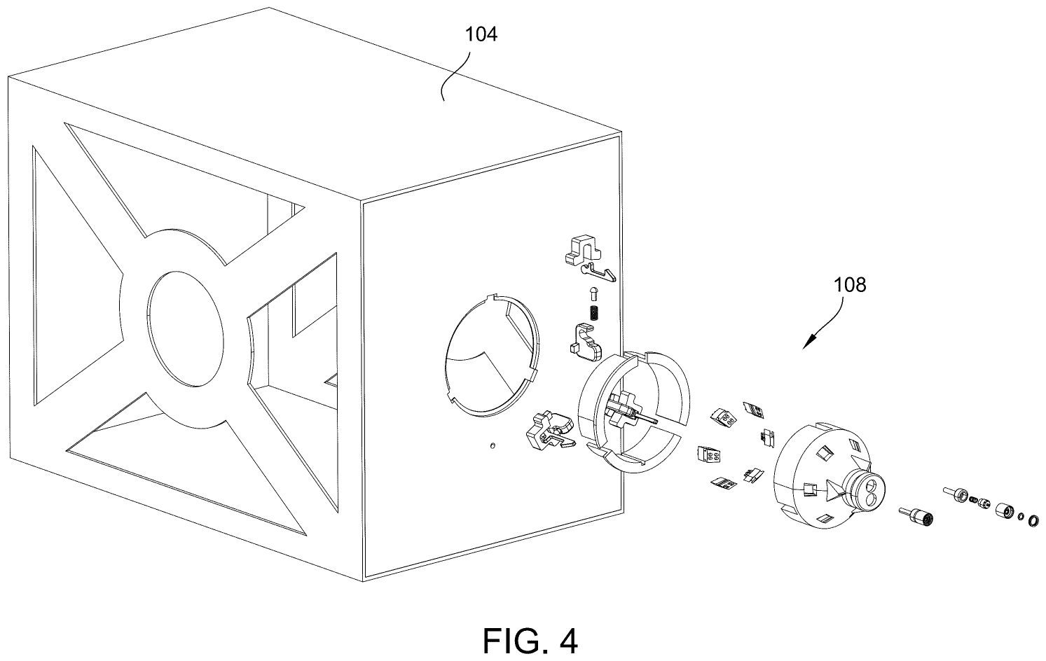

As illustrated in FIGS. 2-5, a docking system 101 is configured to connect the structures 102, 104. The docking system 101 includes a first connector 106 attached to the first in-space structure 102 and a second connector 108 attached to the second in-space structure 104. The docking system 101 provides for secure latching and fastening of structures for servicing, assembly, and manufacturing. The docking system 101 provides many advantages for use with in-space structures. For example, the system provides self-aligning and simple, secure connection mechanisms. The docking system 101 may be used with other structures besides in-space structures that may benefit from the system.

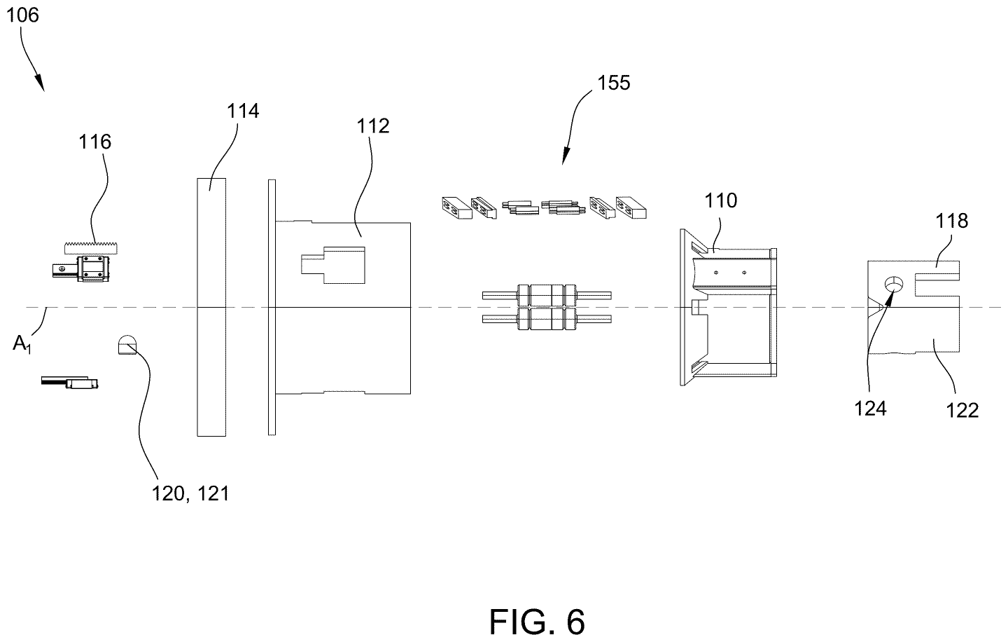

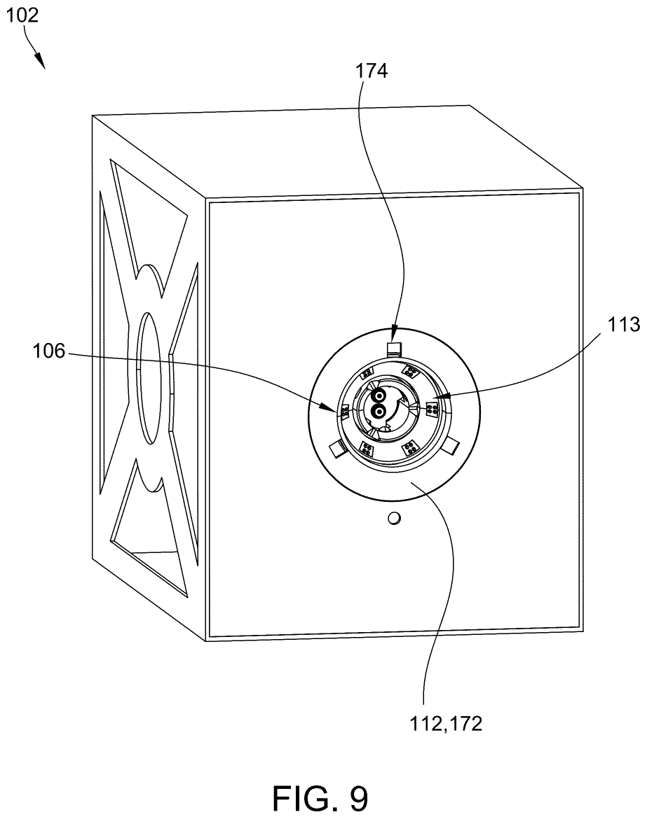

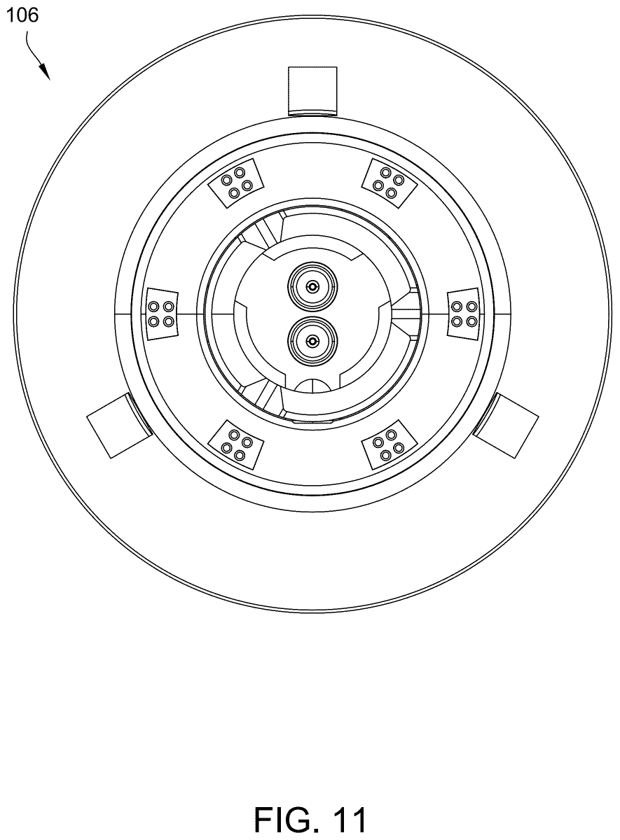

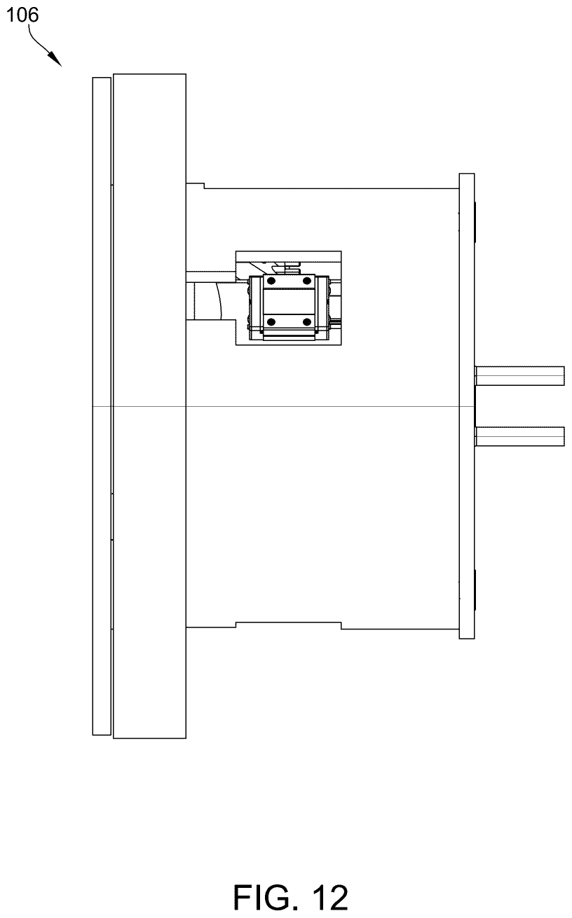

Referring to FIGS. 6 and 9-13, the first connector 106 includes a first housing 110, an actuation sleeve 112, a cam ring 114, an actuation rack 116, a locking sleeve 118 (broadly a “receiver”), and an engagement mechanism 120. The first housing 110 defines a recess 113 (shown in FIG. 9). In the illustrated example, the first housing 110 is a cone. The first housing 110 may be other shapes without departing from some aspects of the disclosure.

In the example, the locking sleeve 118 and the actuation sleeve 112 are each hollows cylinders and defines a recess. The locking sleeve 118 and the actuation sleeve 112 may be other shapes without departing from some aspects of the disclosure.

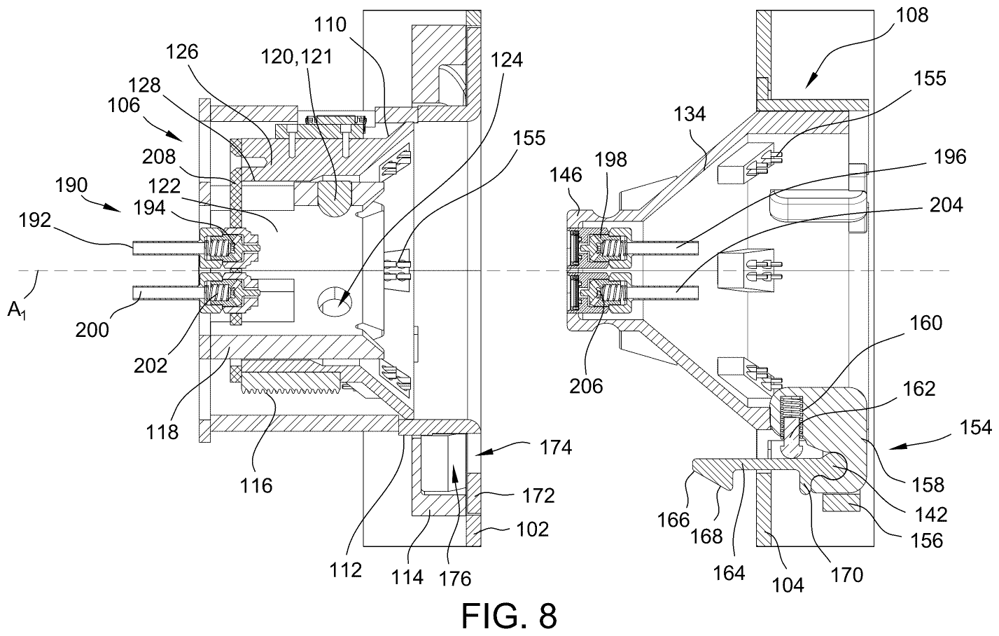

The locking sleeve 118 includes a sleeve wall 122 extending around and along a central axis A1 (shown in FIG. 8). The wall defines openings 124 arranged circumferentially about the central axis A1. In the example, the locking sleeve 118 defines three of the openings 124 uniformly spaced around the circumference of the locking sleeve 118. In other embodiments, the sleeve wall 122 defines one, two, or more than three of the openings 124.

The engagement mechanism 120 may include at least one partially rounded lock member 121 positioned to selectively engage the second connector 108. In the example, the engagement mechanism 120 includes three of the lock members 121 uniformly spaced around the circumference of the sleeve. In the example embodiment, the lock members 121 have a spherocylinder shape, including a rounded hemispherical portion and a cylindrical portion The lock members 121 are positioned in the openings 124 within the locking sleeve 118 and the hemispherical portions extend at least partly into the recess. For example, the sleeve wall 122 has a thickness that is less than a diameter of the lock members 121, and the openings 124 have a diameter that is less than a diameter of the lock members 121. Accordingly, the openings 124 are sized to receive and retain a portion of the lock members 121 without the lock members 121 completely passing through the openings.

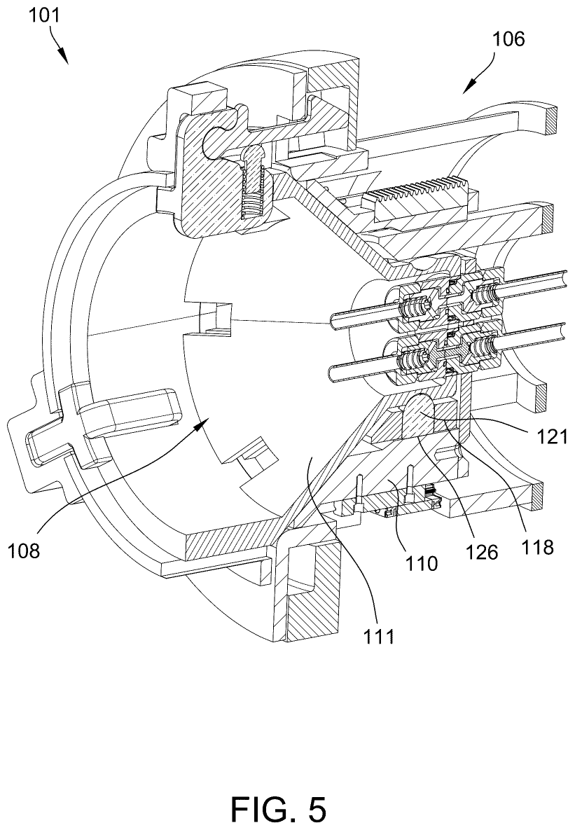

Referring to FIGS. 5 and 8, the first housing 110 includes a retainer 126 that extends around the locking sleeve 118 and contacts the lock members 121, when the first structure 102 and the second structure 104 are docked, as shown in FIG. 5. For example, the retainer 126 includes a sidewall 128 that extends around and is partially engaged on the sleeve wall 122 (shown in FIG. 8). The lock members 121 are retained between the locking sleeve 118 and the retainer 126 of the first housing. As shown in FIG. 8, the sidewall 128 extends along a central axis A1 and defines a cavity sized to receive at least a portion of the lock members 121 when the cavity is aligned with the openings.

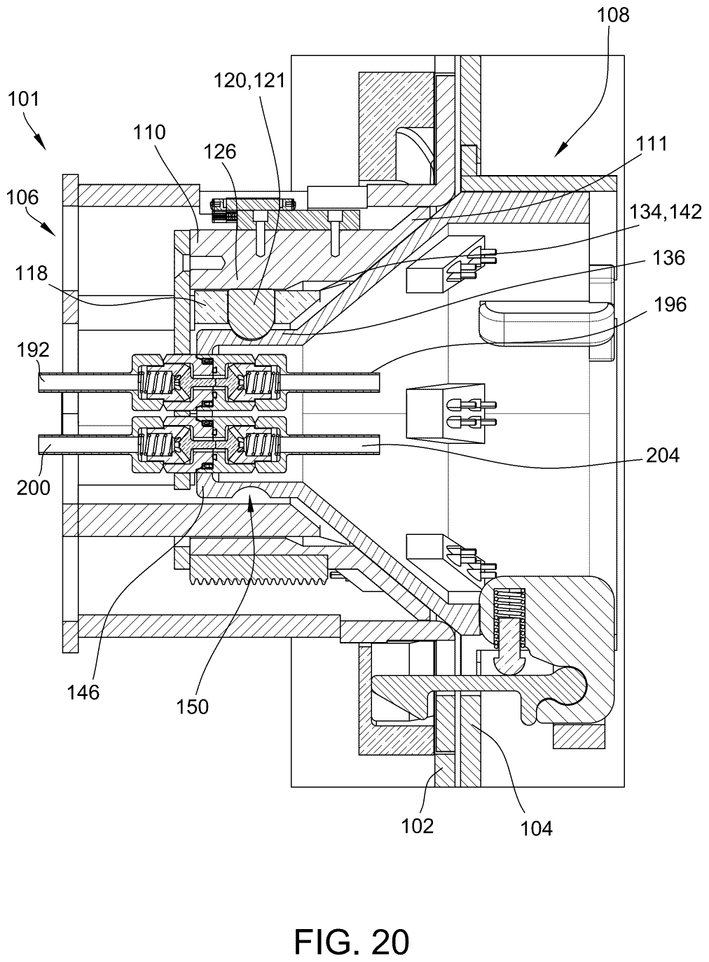

In the example, a rotary actuator is coupled to the first housing and configured to move at least the retainer 126 of the first housing 110 between a first position (shown in FIG. 8) and a second position (shown in FIG. 20). For example, the rotary actuator is configured to rotate and cause axial movement of the first housing 110 through a threaded engagement between the first housing 110 (e.g., by the actuation rack 116) and the rotary actuator. In other embodiments, the rotary actuator may comprise a linear actuator or any other suitable actuator.

In the first position, the retainer 126 allows at least some freedom of movement of the lock members 121 and allows the lock members 121 to extend into or be displaced out of the recess. For example, the retainer 126 of the first housing defines the cavity that allows the lock members 121 to be displaced out of the recess when the retainer is in the first position. The retainer 126 of the first housing is translated along the central axis when the first housing 110 is moved between the first position and the second position. In the second position (shown in FIG. 20), the retainer 126 contacts the lock members 121 and traps the lock members 121 within the openings 124. For example, the retainer 126 of the first housing 110 biases the lock members 121 toward the interior of the locking sleeve 118 such that the lock members 121 are forced partly into the recess when the first housing 110 is in the second position.

Referring to FIG. 8, the sleeve wall 122 prevents the lock members 121 from falling completely into the recess when the first housing 110 is in the first position. In the example, the retainer 126 moves linearly along the central axis between the first position and the second position. In other embodiments, the retainer 126 may be moved in any suitable manner. For example, in some embodiments, the retainer 126 includes a plurality of the cavities (not shown) spaced circumferentially around the central axis. In such embodiments, the retainer 126 may be rotated about the central axis between a first position in which the cavities are aligned with the openings 124 and a second position in which the cavities are not aligned with the openings 124.

In some embodiments, the first structure 102 includes an ejection mechanism for disengaging the first and second structures 102, 104. For example, the ejection mechanism may include an actuator (e.g., a linear or rotary actuator) and/or a push rod. In some embodiments, the actuator and/or the push rod may be omitted.

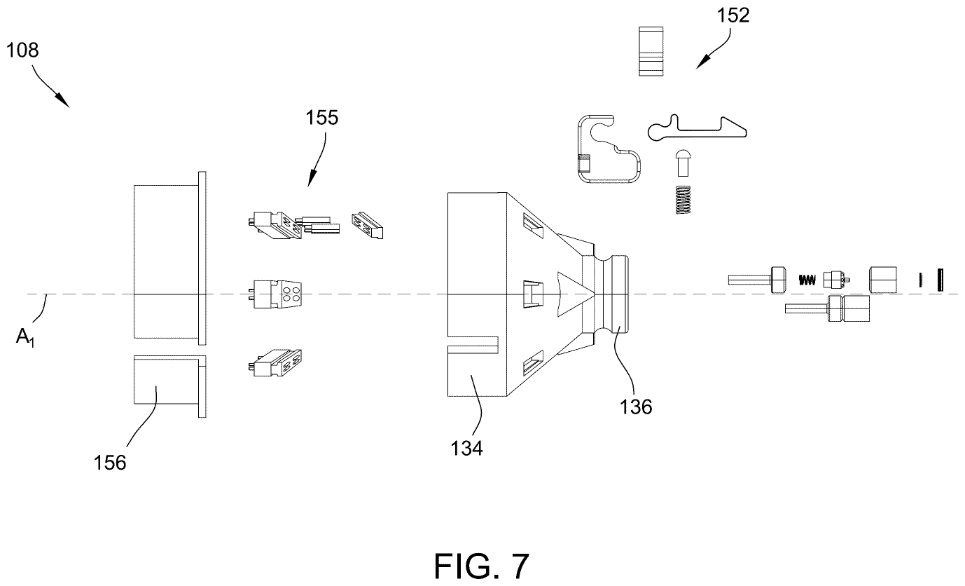

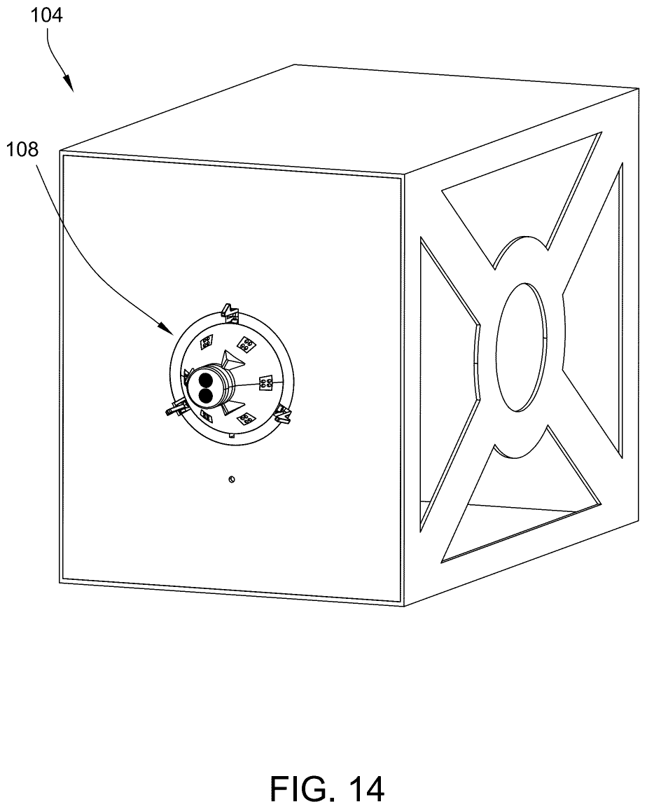

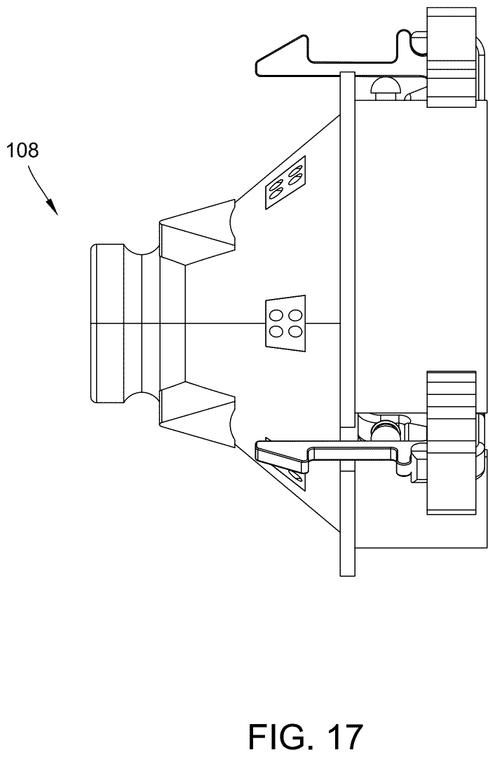

Referring to FIGS. 7 and 14-17, the second connector 108 includes a second housing 134 and at least one connection member 136. The second housing 134 is sized to be received within the recess defined by the first housing 110 (shown in FIG. 8). In addition, the second housing 134 is shaped to match the shape of the first housing 110. For example, the first housing 110 and the second housing 134 are cones. Accordingly, the first housing 110 and the second housing 134 provide a self-aligning feature of the docking system.

In the example, the connection member 136 is fixed in position and does not move when the engagement mechanism 120 (shown in FIG. 8) engages the connection member 136. For example, the connection member 136 and the second housing 134 are constructed as a single piece or are permanently joined together (i.e., the connection member 136 and the second housing 134 cannot be separated without damaging the components) and do not move when engaged by the engagement mechanism 120. In addition, the connection member 136 and the second housing 134 do not include any operable or drivingly movable (e.g., by an actuator) parts that are required for connection to the engagement mechanism 120. Accordingly, the second connector 108 is a passive connector and the second connector 108 is a modular component. As a result, the second connector 108 may be less expensive to manufacture than active components such as the first connector 106 and may incorporated into or attached to in-space structures for widespread adoption at a reduced cost.

In the example, the second housing 134 is fixed in position. In some alternative embodiments, the second connector 108 includes an actuator, e.g. a linear or rotary actuator, that is arranged to move the second housing 134 and the connection member 136 between a stowed position and an extended, engagement position. Alternatively or in addition, an actuator may be arranged to move an outer housing of the second structure 104 to selectively cover at least a portion of the second connector 108.

The connection member 136 is attached to a tip of the second housing 134 and extends along the central axis. The connection member 136 is sized to extend into the recess of the sleeve. For example, the connection member 136 has a diameter that is less than an inner diameter of the sleeve.

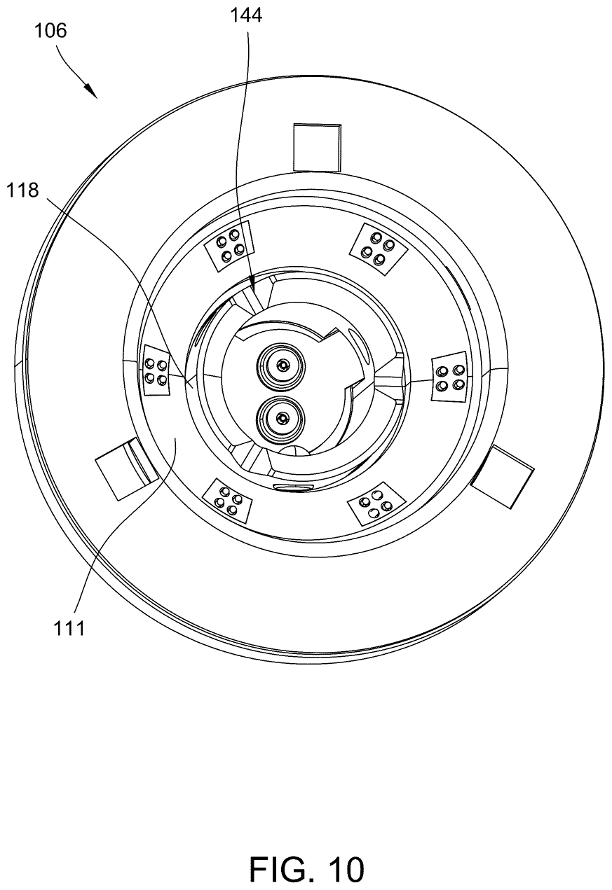

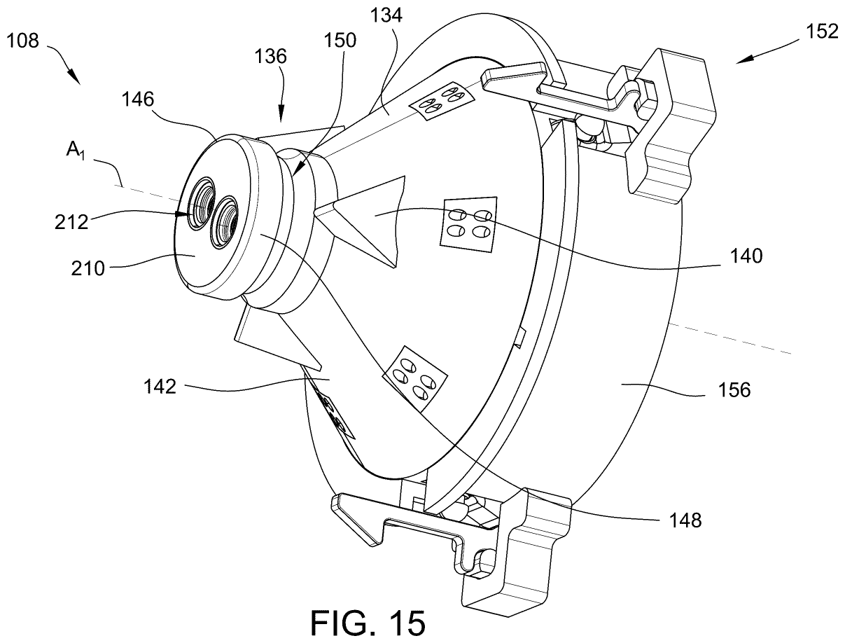

As shown in FIG. 15, in the example, the connection member 136 comprises a protrusion 146 that is mounted on a base 142 of the second housing 134. In addition, the connection member 136 includes alignment wings 140 extending from the base 142. The alignment wings 140 are located on the base 142 on opposite sides of the protrusion 146. The alignment wings 140 are configured to engage notches 144 (shown in FIG. 10) in the locking sleeve 118 of the first connector 106 and facilitate alignment of the connection member 136 and the locking sleeve 118.

In the example, the protrusion 146 is a cylinder and has an outer surface 148 that extends around the central axis A1. The outer surface 148 has a groove 150 defined therein and extending around a circumference of the protrusion 146. The groove 150 is sized and shaped to receive the lock members 121. For example, the groove 150 is curved with a radius that matches a radius of the lock members 121.

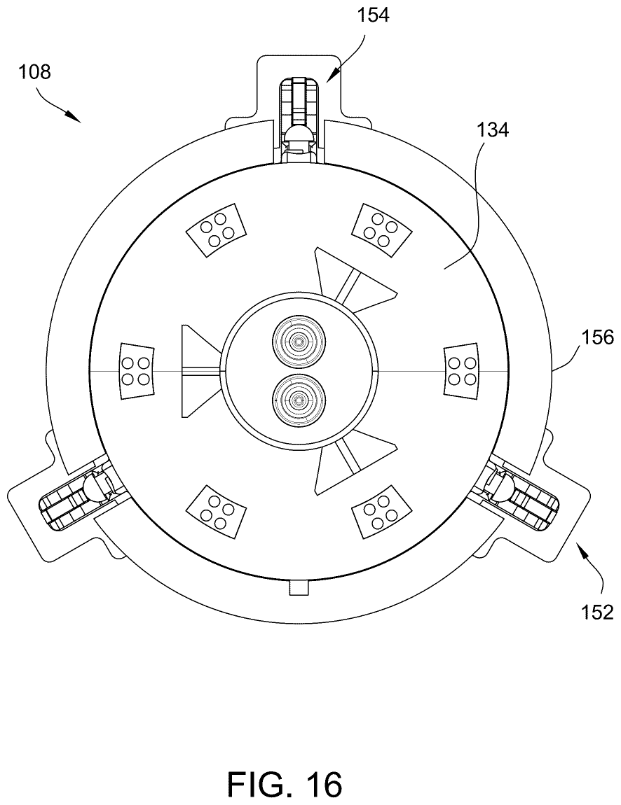

Referring to FIGS. 15 and 16, in the example embodiment, the second connector 108 further includes a passive latch system 152 configured to engage the first connector 106 during docking and prior to contact between the first housing 110 and the second housing 134. The latch system 152 includes a plurality of latches 154 coupled to the second housing 134 and a retaining sleeve 156 of the second connector 108 and positioned circumferentially, and generally evenly spaced, around an outer periphery of the second housing 134 and the retaining sleeve 156. In the example embodiment, the latch system 152 includes three latches 154, though in other embodiments any suitable number of latches 154 may be used. Each of the latches 154 are substantially identical to one another.

FIG. 8 is a cross-section view of the two structures 102, 104 shown in an approach configuration, prior to the first structure 102 and the second structure 104 being docked. The first structure 102 includes the first connector 106 and the second structure 104 includes the second connector 108.

In the example, the central axis A1 extends through center points of the locking sleeve 118, the first housing 110, the second housing 134, the first connector 106 and/or the second connector 108. The central axis A1 is parallel to an insertion axis, along which the second connector 108 is inserted into the first connector during a docking operation. As used herein, the term “axial” refers to an orientation and/or direction generally parallel to the central axis while the term “radial” refers an orientation and/or direction generally perpendicular to the central axis.

As shown in FIG. 8, the latches 154 each include a latch holder 158, a biasing device 160, a plunger 162 (more broadly a “biasing member”), and a latch arm 164. The latch holder 158 is attached to the second housing 134 and the retaining sleeve 156. The biasing device 160 includes a spring coupled to the latch holder 158 and positioned at least partially within a recess defined by the latch holder 158. The plunger 162 is coupled to the biasing device 160 and contacts the latch arm 164, biasing the latch arm 164 radially outward from the central axis A1. The latch arm 164 is hingedly coupled by a hinge (not shown) to the latch holder 158 at a base 142 of the latch arm 164. The latch arm 164 extends axially from the base 142 to a distal latch tip 166 and includes a ramped face 168 at the latch tip 166. In the example embodiment, the latch 154 includes a mechanical stop 170 projecting radially outward from the latch arm 164 proximate the base 142. The mechanical stop 170 restricts rotation of the latch arm 164 to a furthest radial position, as shown in FIG. 8.

In other embodiments, the mechanical stop 170 may include one or more projections on the latch holder 158, the second structure 104, and/or any other structural component of the second connector 108. In further embodiments, the latch arm 164 includes a friction reducing member, such as a ball bearing, optionally positioned at the latch tip 166 to reduce friction between the latch arm 164 and the cam ring 114.

The latch system 152 provides an initial engagement between the first connector 106 and the second connector 108 prior to contact between the first housing 110 and the second housing 134 during docking. In particular, during a docking sequence, contact between the first housing 110 and the second housing 134 may cause a reciprocal force on the first housing 110 and the second housing 134 which, if unrestrained against, may cause the first housing and the second housing 134 to move apart from one another or otherwise generally out of alignment (also referred to herein as “bounce back”). The latches 154 are each configured to engage the first connector 106, prior to contact between the first housing 110 and the second housing 134, to restrict bounce back movement of the first structure 102 and second structure 104 during docking.

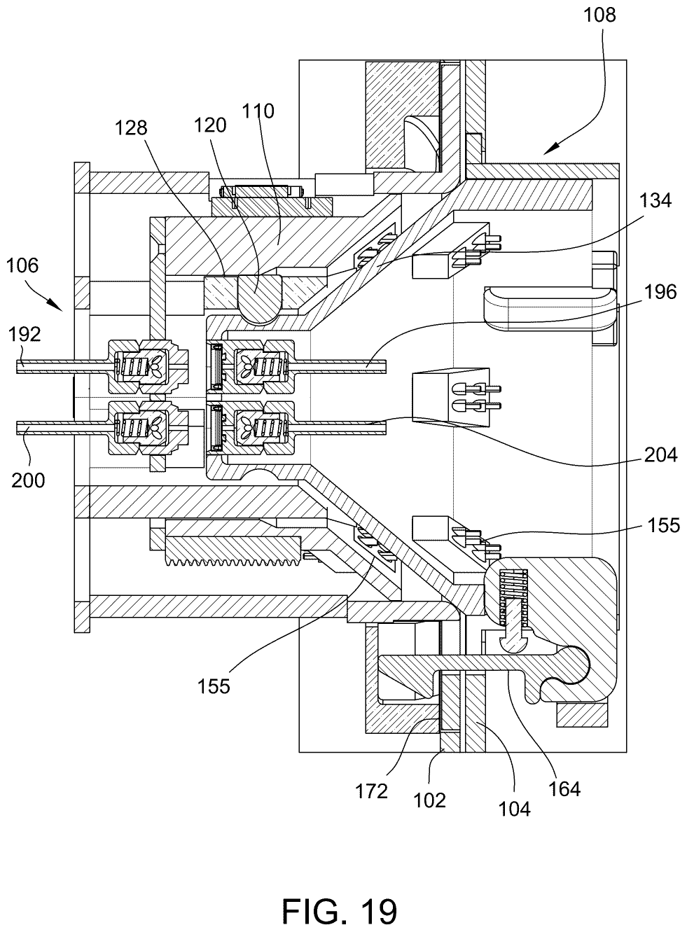

As shown in FIG. 9, the actuation sleeve 112 on the first connector 106 includes an end plate 172 extending radially outward from the first housing 110. The end plate 172 defines a plurality of slots 174 each positioned to be in alignment with a corresponding one of the latches 154 (shown in FIG. 8) on second connector 108. Referring back to FIG. 8, the slots 174 are positioned such that, as the first connector 106 and second connector 108 are moved toward one another, the latch arm 164, and specifically the ramped face 168, contacts and engages the end plate 172, causing the latch arm 164 to pivot radially inward, against the biasing device 160, to be received in the slot 174 and extend into a cam groove 176 defined in the cam ring 114. After the ramped face 168 is clear of the end plate 172, the biasing device 160 biases the latch arm 164 radially outward such that the latch arm 164 engages an inner surface of the end plate 172, as shown in FIG. 19.

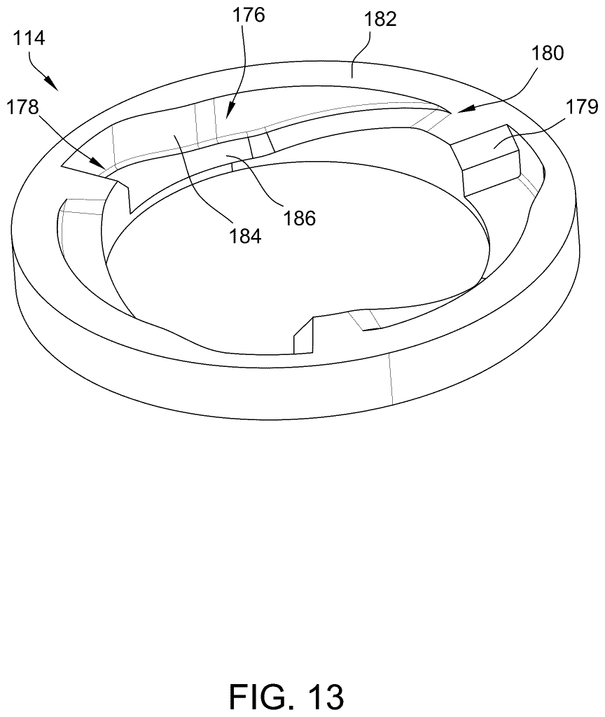

Referring to FIG. 13, the cam ring 114 defines three cam grooves 176 extending at least in part circumferentially around the cam ring 114, each from a first end 178 to a second end 180. Each of the cam grooves 176 is sized and positioned to be aligned with one of the latches 154 (shown in FIG. 8). The cam ring 114 includes an outer surface 182 and each of the grooves 176 are defined by an axial wall 184 extending axially from the outer surface 182 and a recessed surface 186 extending radially inward from the axial wall 184. The axial wall 184 is shaped to extend, at least in part, radially inward between the first end 178 and the second end 180, such that a width of the recessed surface 186 at the second end 180 is less than a width of the recessed surface 186 at the first end 178. Additionally, the recessed surface 186 is ramped axially between the first end 178 and the second end 180 such that a depth of the groove 176 (e.g., as defined between the outer surface 182 and the recessed surface 186) decreases gradually between the first end 178 and the second end 180. For example, the recessed surface extends to the outer surface 182 in the example embodiment. In the example embodiment, the cam ring 114 further includes a ramped ledge 179 extending obliquely to the outer surface 182 and positioned at the first ends 178 of the grooves 176. The ramped ledge 179 is shaped to guide the latch arms 164 into contact with the recessed surface 186.

Referring to FIGS. 8 and 13, in the example embodiment, the cam ring 114 is configured to be selectively controlled to rotate (e.g., by a rotary actuator), during an undocking sequence, to pivot the latches 154 radially inward allowing the latches 154 to be disengaged from the first connector 106. For example, during the docking sequence the cam ring 114 is positioned such that the latches 154 are each positioned in the cam grooves 176 near the first end 178. During the undocking sequence, the cam ring 114 is rotated (e.g., approximately 120 degrees in the example) to align the second ends 180 of the cam grooves 176 with the latches 154. During rotation, the latches are engaged by the axial wall 184 and the recessed surface 186, thereby providing a force on the latches 154 at least partially radially inward and axially outward, such that the latches 154 may disengage the end plate 172 as the second connector 108 is moved axially away from the first connector 106. In other embodiments, the cam ring 114 may include any suitable shape that enables the docking system 101 to function as described herein.

As shown in FIG. 8, the first connector 106 and the second connector 108 each include electrical contacts 155 that are configured to provide an electrical connection between the first structure 102 and the second structure 104. For example, the electrical contacts 155 each include conductors that allow electrical current to flow through when the conductors are in contact with another conductor. Each electrical contact 155 on the first structure 102 is paired with a corresponding electrical contact 155 on the second structure 104.

Each electrical contact 155 may extend along an axis and have elongated casing or housing that protects the conductors. In some embodiments, the electrical contacts 155 on the first connector 106 and/or the electrical contacts 155 on the second connector 108 are positionable between a stowed position and an engagement position. The electrical contacts 155 may be biased toward the engagement position by a bias mechanism such as a spring. In the example embodiment, the electrical contacts each include pogo pins. In the engagement position, the electrical contacts 155 extend through openings in the first housing 110 and the second housing 134 to provide an electrical connection between electrical components. The electrical contacts 155 may provide connections for power and/or data transfer between the structures 102, 104.

In the example, the docking system 101 includes a fluid transfer system 190. The fluid transfer system 190 includes a first fluid line 192, a first valve 194, a second fluid line 196, a second valve 198, a third fluid line 200, a third valve 202, a fourth fluid line 204, and a fourth valve 206. When docked, the fluid transfer system 190 forms two continuous fluid lines between the first fluid line 192 and the second fluid line 196 and the third fluid line 200 and the fourth fluid line 204. In other embodiments, the fluid transfer system 190 may include any suitable number of fluid lines. For example, in some embodiments, the fluid transfer system 190 does not include the third fluid line 200 and the fourth fluid line 204.

In the example, each of the fluid lines 192, 196, 200, 204 are connected to fluid sources and/or fluid reservoirs and arranged for transferring fluid between the first structure 102 and the second structure 104. For example, the first and third fluid lines 192, 200 may be connected to a fluid source (not shown) on the first structure 102. The second and fourth fluid lines 196, 204 may be connected to a fluid reservoir (not shown) on the second structure 104. In other embodiments, the fluid source may be located on the second structure 104 and/or the fluid reservoir may be located on the first structure 102.

The fluid lines 192, 196, 200, 204 each extend through bores in the first and second connectors 106, 108 and are configured to transfer a fluid, e.g., fuel. The fluid may include materials in a liquid and/or a gas state. In particular, in the example embodiment, the first valve 194 and the third valve 202 extend through an end wall 208 of the first housing 110, such that ends of the valves 194, 202 are accessible within the recess defined by the first housing 110. The second valve 198 and the fourth valve 206 are each positioned at least partially within the protrusion 146. As shown in FIG. 15, an end face 210 of the protrusion 146 defines end bores 212 through which the valves 198, 206 are accessible

The fluid transfer system 190 facilitates simple and secure attachment of the first valve 194 to the second valve 198 and facilitates fluid transfer, e.g., liquid, gas fuel, and/or pressurant in a gas state transfer, between two structures 102, 104.

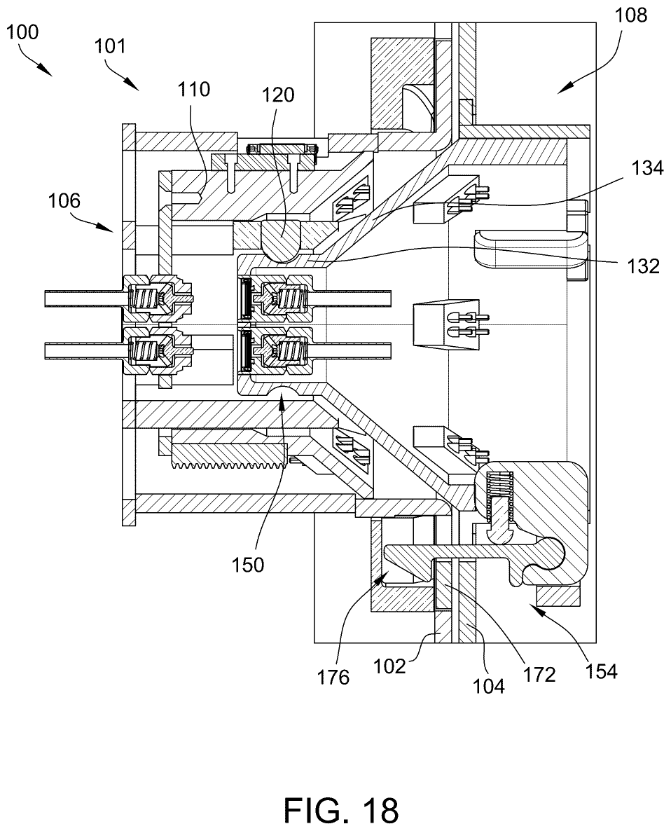

FIGS. 18-20 are cross-section views of the portion of the securable assembly 100 shown in FIG. 8, showing subsequent stages of an example docking process, subsequent to the approach configuration shown in FIG. 8.

In the example embodiment, first structure 102 and second structure 104 each include one or more onboard controllers each including a processor in communication with a memory storing instructions thereon, collectively referred to herein as a “control system”. In some embodiments, the control system may include a first central controller on the first structure 102 and a second central controller on the second structure 104. The control system may include one or more Rendezvous and Proximity Operations (“RPO”) systems and propulsion systems of the first and/or second structure. The control system may be in communication with any of the sensors, actuators, and/or propulsion systems described herein. The control system is configured to control the actuators, and/or propulsion systems to automatically perform any of the docking or undocking operations described herein. The control system is configured to be in communication with a remote (e.g., ground operated) controller. In some embodiments, one or more of the docking and/or undocking operations described herein may be performed in response to and/or based on one or more commands received from the remote controller.

FIG. 18 is a cross-section view of the two structures 102, 104 shown in a first docking configuration, also referred to herein as a “latch” or soft configuration. During operation, a positioning of the first structure 102 and/or the second structure 104 is initially controlled by the control system.

In the first docking configuration, the second housing 134 of the second connector 108 is positioned partially within the recess defined by the first housing 110 of the first connector 106 and the engagement mechanism 120 of the first connector 106 is aligned with the connection member 136, and more specifically the groove 150, of the second connector 108. The first structure 102 is not in contact with the second structure 104 and the first housing 110 is not in contact with the second housing 134. As shown in FIG. 18, the latch 154 is received within the cam groove 176 and engaged with the end plate 172. As a result, in the first docking configuration, the latches 154 on the first connector 106 are the first structural component to be engaged with the second connector 108 and are configured to restrain any bounce-back between the structures 102, 104 during subsequent docking procedures.

In some embodiments, the first structure 102, the second structure 104, the first connector 106, and or the second connector 108 may include one or more sensor systems configured to detect a position and/or alignment of the first connector and the second connector 108. The sensor systems may be in communication with the control system and the control system may control the docking/undocking processes based on readings from the one or more sensor systems. For example, in some embodiments, the first and/or second connector 108, and/or the first structure 102 or the second structure 104, may include one or more proximity sensors configured to detect a position of the first connector 106 relative to the second connector 108. In one embodiment, the first structure 102 and the second structure 104 each include spring loaded grounding pins (not shown) that contact when the docking system 101 is in the first configuration and provide an electrical signal to the control system indicating correct alignment of the first connector 106 and second connector 108.

FIG. 19 is a cross-section view of the two structures 102, 104 shown in a second docking configuration subsequent to the first docking configuration, also referred to herein as a “soft dock” configuration. In the second docking configuration, the first housing 110 is moved axially, from the first docking configuration, toward the second housing 134 such that the retainer 126 is at least partially aligned with the engagement mechanism 120. In both the first docking configuration and the second docking configurations, the connections of the fluid lines 192, 196, 200, 204 and electrical contacts 155 are not established.

FIG. 20 is a cross-section view of the two structures 102, 104 shown in a third docking configuration subsequent to the second docking configuration, also referred to herein as a “hard dock” configuration. In the third docking configuration, the first housing 110 is moved axially, from the second docking configuration, toward the second housing 134 such that the retainer 126 is fully aligned with the engagement mechanism 120 and the engagement mechanism 120 is engaged with the connection member 136. For example, the sleeve 118 is sized to receive the protrusion 146 of the connection member 136. The lock members 121 each extended into the groove 150 on the protrusion 146 to secure the connection member 136 and the sleeve of the first connector 106 together. In the third docking configuration, the first housing 110 is in contact with the second housing 134. In particular, the first housing 110 and the second housing 134 are engaged by a compressive force between the base 142 of the second housing 134 and the radially flared rim 111 of the first housing 110. The first housing 110 is translated axially such that the first housing 110 applies the compressive force to the second housing 134. The second housing 134 is restrained against the compressive force by the engagement between the engagement mechanism 120 and the connection member 136, thereby establishing a preloading between the first connector 106 and the second connector 108 and strengthening the connection between the first connector 106 and the second connector 108. In the example embodiment, the preload between the first connector 106 and the second connector 108 is greater than 500 pounds, greater than 1,000 pounds, and/or greater than 1,500 pounds. In the example embodiment, the preload between the first connector 106 and the second connector 108 is approximately 1,500 pounds.

In the third docking configuration, the electrical contacts 155 on the first housing 110 (shown in FIG. 8) are in contact and electrically connected with the electrical contacts 155 (shown in FIG. 8) on the second housing 134. The electrical contacts 155 establish electrical connection between the first structure 102 and the second structure 104, enabling power and data transfer between the two structures 102, 104. Additionally, the first fluid line 192 and the third fluid line 200 on the first connector 106 are connected with the second fluid line 196 and the fourth fluid line 204, respectively, on the second connector 108. The connected fluid lines 192, 196, 200, 204 enable transfer of fluid, such as fuel, gasses, etc., between the first structure 102 and the second structure 104.

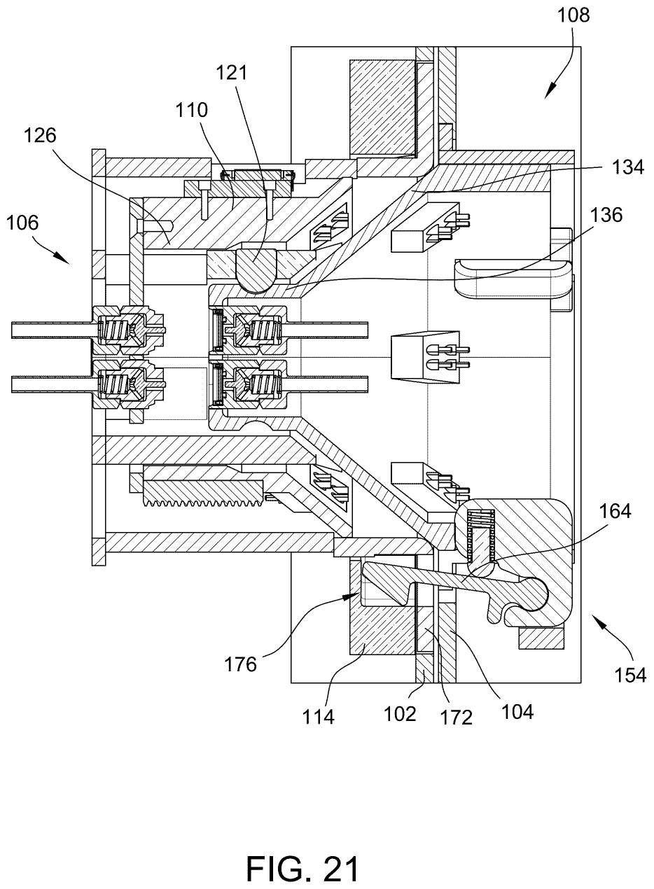

FIG. 21 is a cross-section view of the two structures 102, 104 shown in a first undocking configuration. In the first undocking configuration, the first housing 110 is moved axially away from the second housing 134, such that the lock members 121 of the engagement mechanism 120 are spaced from the retainer 126 and may retract radially outward to disengage from the connection member 136. In some embodiments, the fluid lines 192, 196, 200, 204 are first disengaged (e.g., by an independent actuator and/or by movement of the first housing 110 relative to the second housing 134. Additionally, the cam ring 114 is rotated causing the latches 154, and specifically, the latch arms 164 to deflect radially inward. As shown in FIG. 21, the cam ring 114 is rotated such that the latches 154 are in a first intermediate position between the first end 178 and the second end 180 of the cam grooves 176 (shown in FIG. 13). In the example embodiment, rotation of the cam ring 114 provides an axial ejection force on the second structure 104 (e.g., translated through the latches 154), causing the first structure 102 and the second structure 104 to axially diverge from one another. The axial ejection force is distributed substantially uniformly among the three latches 154. Further rotation of the cam ring 114 from the intermediate position shown in FIG. 21 causes the latches 154 to further deflect until the latches 154 are clear of the end plate 172, allowing for a complete separation of the first structure 102 and the second structure 104.

Referring to FIG. 8, the first valve 194 of the fluid transfer system 190 is coupled to the first fluid line 192 and positioned on the first connector 106 and the second valve 198 is coupled to the second fluid line 196 and positioned on the second connector 108 (shown in FIG. 8). The third valve 202 and the fourth valve 206 are substantially identical to the first and second valves 194, 198, respectively.

In the example embodiment, the second structure 104 is configured to be serviced by fluid transfer from the first structure 102, such that fluid flows from the first valve 194 into the second valve 198 during the fluid transfer. As such the first valve 194 may alternatively be referred to herein as a “dispensing valve”, while the second valve 198 may alternatively be referred to herein as a “receiving valve”. In other embodiments, the first valve 194 and the second valve 198 may be coupled to opposite one of structures 102, 104, such that the first structure 102 is configured to receive fluid dispensed from the second structure 104. In further embodiments, the first valve 194 may receive fluid dispensed through the second valve 198.

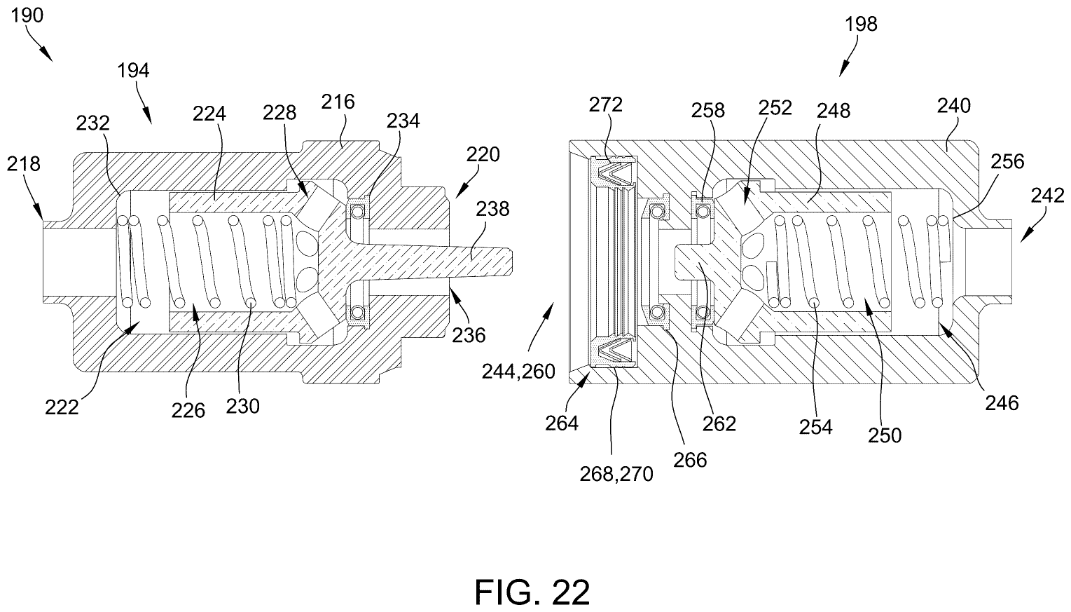

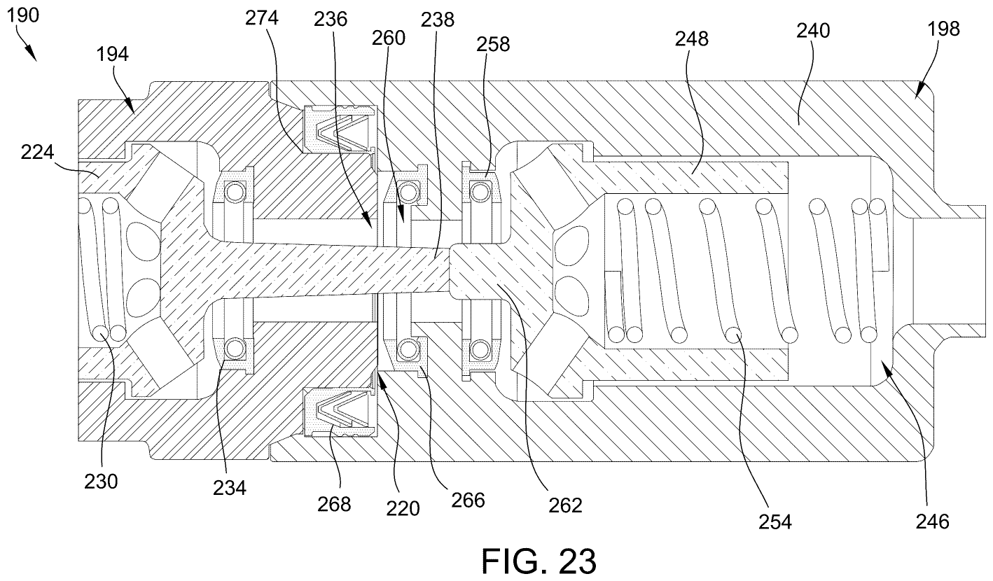

FIGS. 22 and 23 show a portion of the fluid transfer system 190, showing the first valve 194 and the second valve 198. FIG. 22 shows the first valve 194 and the second valve 198 in an uncoupled configuration. FIG. 23 shows the first valve 194 and the second valve 198 in a coupled configuration.

In the example embodiment, the first valve 194 includes a first valve housing 216 extending from a first line end 218 to a first coupling end 220. The first valve 194 is configured to fluidly connect to the first fluid line 192 (shown in FIG. 8) at the first line end 218.

The first valve housing 216 defines a first valve chamber 222 therein. The first valve chamber 222 is in flow communication with the first line end 218. A first valve body 224 is received within the first valve chamber 222 and defines a first interior chamber 226 and a plurality of passageways 228 in flow communication with the interior chamber 226. A first biasing device 230 is positioned within the first valve chamber 222 and extends from a first end wall 232, within the first interior chamber 226. The first biasing device 230 engages the first valve body 224 to bias the valve body 224 into engagement with a first chamber seal 234. As shown in FIG. 22, when the first valve 194 is closed, the first chamber seal 234 and the first valve body 224 restrict flow communication between the first valve chamber 222 and a first opening 236 of the first valve housing 216, defined at the first coupling end 220. The first valve 194 body includes a needle portion 238 projecting axially outward of the first opening 236.

The second valve 198 includes a second valve housing 240 extending from a second line end 242 to a second coupling end 244. The second valve 198 is configured to fluidly connect to the second line 196 (shown in FIG. 8) at the second line end 242. The second valve housing 240 defines a second valve chamber 246 therein. The second valve chamber 246 is in flow communication with the second line end 242. A second valve body 248 is received within the second chamber 246 and defines a second interior chamber 250 and a plurality of passageways 252 in flow communication with the second interior chamber 250. A second biasing device 254 is positioned within the second valve chamber 246 and extends from a second end wall 256, within the second interior chamber 250. The second biasing device 254 engages the second valve body 248 to bias the second valve body 248 into engagement with a second chamber seal 258. As shown in FIG. 22, when the second valve 198 is closed, the second chamber seal 258 and the second valve body 248 restrict flow communication between the second valve chamber 246 and a second opening 260 of the second valve housing 240, defined at the second coupling end 244. The second valve body includes a plug portion 262 recessed axially inward of the second coupling end 244.

In the example embodiment, the second valve 198 includes a valve seat 264 sized and shaped to receive the first coupling end 220 of the first valve 194 therein. A first coupling seal 266 and a second coupling seal 268 are positioned in the valve seat 264 and are configured to engage the first valve housing 216, when the first valve 194 is in the coupled configuration, as shown in FIG. 23. The second coupling seal 268 includes a seal housing 270 and one or more resilience members 272 positioned inside of the seal housing 270. The resilience members 272 are shaped to provide a radially outward force on the seal housing 270 in response to compression of the seal housing 270. In the example embodiment, the housing 270 includes a polytetrafluoroethylene (“PTFE”) material and the resilience members include a plurality of metal springs. In other embodiments, the second coupling seal 268 may be formed of any suitable materials that enable the fluid transfer system 190 to function as described herein.

Referring to FIG. 23, in the coupled configuration, the first valve 194 includes a ledge 274 extending radially that engages the second coupling seal 268 and the first coupling end 220 engages the first coupling seal 268, restricting fluid flow from leaking between the first valve 194 and the second valve 198. The needle portion 238 of the first valve body 224 extends into the second valve housing 240 axially between the first coupling seal 266 and the second chamber seal 258. The needle portion 238 engages the plug portion 262 of the second valve body 248, deflecting each of the first valve body 224 and the second valve body 248 axially in opposed directions and against the biasing forces of the first biasing device 230 and the second biasing device 254. The deflection of the first valve body 224 axially away from the first chamber seal 234 provides a fluid flow path therebetween, allowing fluid flow between the first valve chamber 222 (shown in FIG. 21) and the first opening 236, thereby opening the first valve 194. Likewise, the deflection of the second valve body 248 from the second chamber seal 258 provides a fluid flow path therebetween, allowing fluid flow between the second valve chamber 246 and the second opening 260, thereby opening the second valve 198. As shown in FIG. 23, with the first valve 194 and second valve 198 open, fluid may be transferred between the first valve 194 and the second valve 198.

In the example embodiment, the first valve 194 and the second valve 198 are each “passively actuated” valves, in that they are opened mechanically in response to engagement with a corresponding portion of the opposed valves and are automatically closed (e.g., by the biasing force provided by biasing devices 230, 254) in response to disengagement. In the example embodiments, the first valve 194 and the second valve 198 are positioned on the first connector 106 and the second connector 108 (shown in FIG. 8) such that the first valve 194 and the second valve 198 are mutually engaged (e.g., based on their fixed positions), when the first connector 106 and the second connector 108 are in the hard dock configuration. In other embodiments, the first valve 194 and/or the second valve 198 may be configured to be moved by an external actuator into the engaged position separately from coupling of the first connector 106 to the second connector 108. For example, in one embodiment, the second valve 198 is fixed in position on the second connector 108 and the first valve 194 is configured to be driven axially by a linear actuator between a recessed position and the engaged position independently of movement of the first housing 110. In further embodiments, the first fluid line 192 and/or the second fluid line 196 may include one or more selectively controllable valves (not shown). In some such embodiments, the selectively controllable valves may restrict fluid transfer between the first valve 194 and the second valve 198 and may be opened after one or more sensors detects that the first valve 194 and the second valve 198 are each properly coupled and/or opened.

Example embodiments of docking systems are described above. The systems and methods are not limited to the specific embodiments described herein, but rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A docking system for use with in-space structures, the docking system comprising:
a first connector attached to a first in-space structure, the first connector including a first housing defining a central axis and an engagement mechanism positioned within the first housing, the engagement mechanism being movable relative to the first housing; and
a second connector attached to a second in-space structure, the second connector including a second housing including a base and a connection member, wherein the engagement mechanism is operable to engage the connection member, and wherein the connection member is fixed in position on the second in-space structure and does not move relative to the second in-space structure when the engagement mechanism engages the connection member.

2. A docking system in accordance with claim 1, wherein the first connector includes a sleeve defining a recess sized to receive the connection member, and wherein the engagement mechanism is configured to engage the connection member when the connection member is in the recess.

3. A docking system in accordance with claim 2, wherein the engagement mechanism comprises a ball that is biased toward and engages the connection member when the connection member is in the recess.

4. A docking system in accordance with claim 1 further comprising a fluid valve accessible through an end of the connection member.

5. A docking system in accordance with claim 1 further comprising an actuator configured to move the engagement mechanism between a first position and a second position, wherein the engagement mechanism is configured to engage the connection member when the connection member is positioned within the first housing and the engagement mechanism is in the second position.

6. A docking system in accordance with claim 1, wherein the first connector includes a slot defined in an end plate of the first connector, the second connector including a latch assembly including a latch positioned radially outward from the second housing, wherein the latch is configured to be received in the slot and engage the end plate, during a docking operation, while the first housing is spaced from the second housing.

7. A docking system in accordance with claim 6, wherein the latch projects axially outward from the second in-space structure.

8. A docking system in accordance with claim 6, wherein the latch includes a latch holder attached to the second housing, a latch arm hingedly connected to the latch holder, and a biasing device biasing the latch arm radially outward from the second housing.

9. A docking system in accordance with claim 8, wherein the first connector includes a cam ring rotationally connected to the first housing, the cam ring being selectively controllable to rotate about the first housing between a first position and a second position, the cam ring defining a groove therein, wherein the groove is sized to receive a tip of the latch arm when the cam ring is in the first position, and wherein rotation of the cam ring from the first position to the second position causes the latch arm to deflect against the biasing device and out of engagement with the end plate.

10. A docking system in accordance with claim 1 further comprising:
a first plurality of electrical contacts attached to the first housing;
a second plurality of electrical contacts attached to the second housing, the first plurality of electrical contacts and the second plurality of electrical contacts configured to be electrically coupled to provide at least one of a power and data connection between the first in-space structure and the second in-space structure;
a first fluid valve attached to the first housing; and
a second fluid valve attached to the second housing, wherein the first fluid valve and the second fluid valve are configured to be connected to enable a fluid transfer between the first in-space structure and the second in-space structure.

11. A docking system in accordance with claim 10, wherein the first housing is moveable relative to the first in-space structure from a first position, in which the first plurality of electrical contacts and the second plurality of electrical contacts are decoupled and the first fluid valve is disconnected from the second fluid valve, to a second position, wherein movement of the first housing to the second position electrically couples the first plurality of electrical contacts with the second plurality of electrical contacts and connects the first fluid valve to the second fluid valve.

12. A docking system in accordance with claim 1, wherein the first connector includes an actuator configured to move the first housing relative to the first in-space structure in an axial direction parallel to the central axis, wherein movement of the first housing causes the engagement mechanism to move relative to the first housing, and
wherein the second connector is a passive connector.

13. A method of connecting in-space structures, the method comprising:
moving a first in-space structure relative to a second in-space structure, the first in-space structure including a first connector including a first housing defining a central axis and an engagement mechanism positioned within the first housing, the engagement mechanism being movable relative to the first housing, the second in-space structure including a second connector including a second housing, the second housing including a base and a connection member; and
engaging with the engagement mechanism the connection member within the engagement mechanism, wherein the connection member is fixed in position on the second in-space structure and does not move relative to the second in-space structure when the engagement mechanism engages the connection member.

14. A method in accordance with claim 13, wherein the first connector includes a slot defined in an end plate of the first connector, the second connector including a latch assembly including a latch positioned radially outward from the second housing, wherein the method includes:
receiving the latch in the slot; and
engaging the latch with the end plate, prior to engaging the connection member with the engagement mechanism and with the first housing spaced from the second housing.

15. A method in accordance with claim 14, wherein the latch projects axially outward from the second in-space structure.

16. A method in accordance with claim 14, wherein the latch includes a latch holder attached to the second housing, a latch arm hingedly connected to the latch holder, and a biasing device biasing the latch arm radially outward from the second housing.

17. A method in accordance with claim 16, wherein the first connector includes a cam ring rotationally connected to the first housing, the cam ring being selectively controllable to rotate about the first housing between a first position and a second position, the cam ring defining a groove therein, wherein the groove is sized to receive a tip of the latch arm when the cam ring is in the first position, and wherein rotation of the cam ring from the first position to the second position causes the latch arm to deflect against the biasing device and out of engagement with the end plate.

18. A method in accordance with claim 13, wherein the first in-space structure further includes a first plurality of electrical contacts attached to the first housing and a first fluid valve attached to the first housing, the second in-space structure includes a second plurality of electrical contacts attached to the second housing and a second fluid valve attached to the second housing,
wherein the first plurality of electrical contacts and the second plurality of electrical contacts configured to be electrically coupled to provide at least one of a power and data connection between the first in-space structure and the second in-space structure, and
wherein the first fluid valve and the second fluid valve are configured to be connected to enable a fluid transfer between the first in-space structure and the second in-space structure.

19. A method in accordance with claim 18 further comprising:
moving the first housing relative to the first in-space structure from a first position in which the first plurality of electrical contacts and the second plurality of electrical contacts are decoupled and the first fluid valve is disconnected from the second fluid valve, to a second position, wherein movement of the first housing to the second position electrically couples the first plurality of electrical contacts with the second plurality of electrical contacts and connects the first fluid valve to the second fluid valve.

20. A method in accordance with claim 13, wherein the first connector includes an actuator configured to move the first housing relative to the first in-space structure in an axial direction parallel to the central axis, wherein movement of the first housing causes the engagement mechanism to move relative to the first housing, and
wherein the second connector is a passive connector.
